(19) United States
(12) Patent Application Publication
(10) Pub. No.: US 2023/0294286 A1
(43) Pub. Date: Sep. 21, 2023

(54) Robot Controller And Robot System

(71) Applicant: SEIKO EPSON CORPORATION, Tokyo (JP)

(72) Inventors: Shunichi MIZUOCHI, Matsumoto (JP); Kazuhiro MASUDA, Matsumoto (JP); Tsunemori ASAHI, Azumino (JP); Koki YAMAGUCHI, Matsumoto (JP)

(21) Appl. No.: 18/184,408

(22) Filed: Mar. 15, 2023

(30) Foreign Application Priority Data
Mar. 16, 2022 (JP) 2022-041305

(51) Int. Cl. B25J 9/16; H04L 12/40

(52) U.S. Cl. CPC B25J 9/1664; B25J 9/161; H04L 12/40189; H04L 2012/4026

(57) ABSTRACT

A robot controller controlling a robot arm driven by a motor is provided. The robot controller includes: a first processing unit having a first control unit, a first storage unit, and a first system bus that couples the first control unit and the first storage unit together, the first processing unit acquiring target position information designated in a program causing the robot arm to operate; and a second processing unit having a second control unit, a second storage unit, and a second system bus that couples the second control unit and the second storage unit together, the second processing unit receiving the target position information from the first processing unit and generating a trajectory of the robot arm, based on the target position information.

The present application is based on, and claims priority from JP Application Serial Number 2022-041305, filed Mar. 16, 2022, the disclosure of which is hereby incorporated by reference herein in its entirety.

### BACKGROUND

### 1. Technical Field

The present disclosure relates to a robot controller and a robot system.

### 2. Related Art

For example, JP-A-9-323279 describes an integrated control system for work robot, the system including a CPU for robot control, a CPU for work tool control, a CPU for peripheral device control, an energy management CPU, a shared memory, and a system bus integrating these CPUs and the memory. Also, providing a cache memory in a CPU in order to increase the processing speed is generally known.

However, in such an integrated control system for work robot, since the shared memory and the system bus are shared while a plurality of CPUs are provided, a CPU other than CPUs to which trajectory control and servo control are allocated may occupy the shared memory and the system bus in some cases. Consequently, there is a risk that the trajectory control and the servo control may be delayed, resulting in a drop in the productivity of the robot.

### SUMMARY

According to an aspect of the present disclosure, a robot controller controlling a robot arm driven by a motor is provided. The robot controller includes: a first processing unit having a first control unit, a first storage unit, and a first system bus that couples the first control unit and the first storage unit together, the first processing unit acquiring target position information designated in a program causing the robot arm to operate; and a second processing unit having a second control unit, a second storage unit, and a second system bus that couples the second control unit and the second storage unit together, the second processing unit receiving the target position information from the first processing unit and generating a trajectory of the robot arm, based on the target position information.

According to another aspect of the present disclosure, a robot system includes: a robot having a robot arm; and a robot controller controlling driving of the robot arm. The robot controller includes: a first processing unit having a first control unit, a first storage unit, and a first system bus that couples the first control unit and the first storage unit together, the first processing unit acquiring target position information designated in a program causing the robot arm to operate; and a second processing unit having a second control unit, a second storage unit, and a second system bus that couples the second control unit and the second storage unit together, the second processing unit receiving the target position information from the first processing unit and generating a trajectory of the robot arm, based on the target position information.

### BRIEF DESCRIPTION OF THE DRAWINGS

FIG. 1 shows an overall configuration of a robot system according to a preferred embodiment.

FIG. 2 is a block diagram of a robot controller.

FIG. 3 is a modification example of the block diagram of the robot controller shown in FIG. 2.

### DESCRIPTION OF EXEMPLARY EMBODIMENTS

The robot controller and the robot system according to the present disclosure will now be described in detail, based on a preferred embodiment shown in the accompanying drawings.

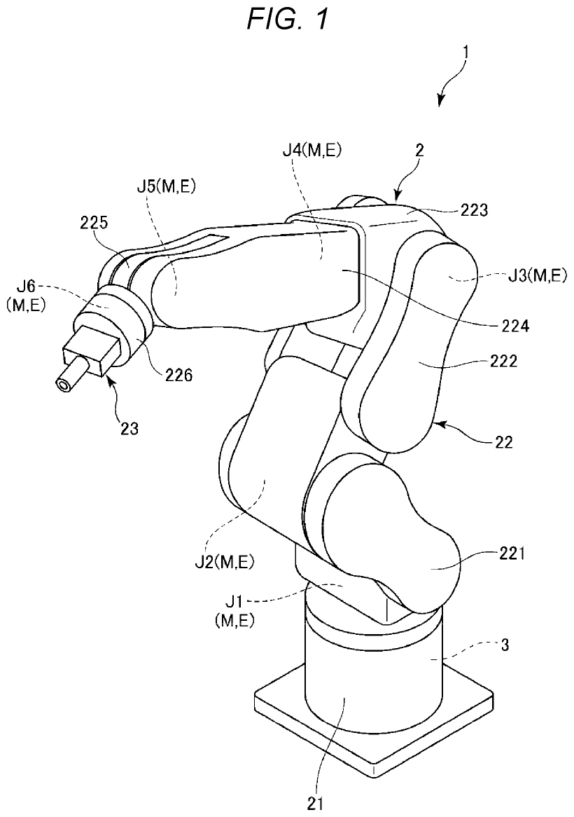

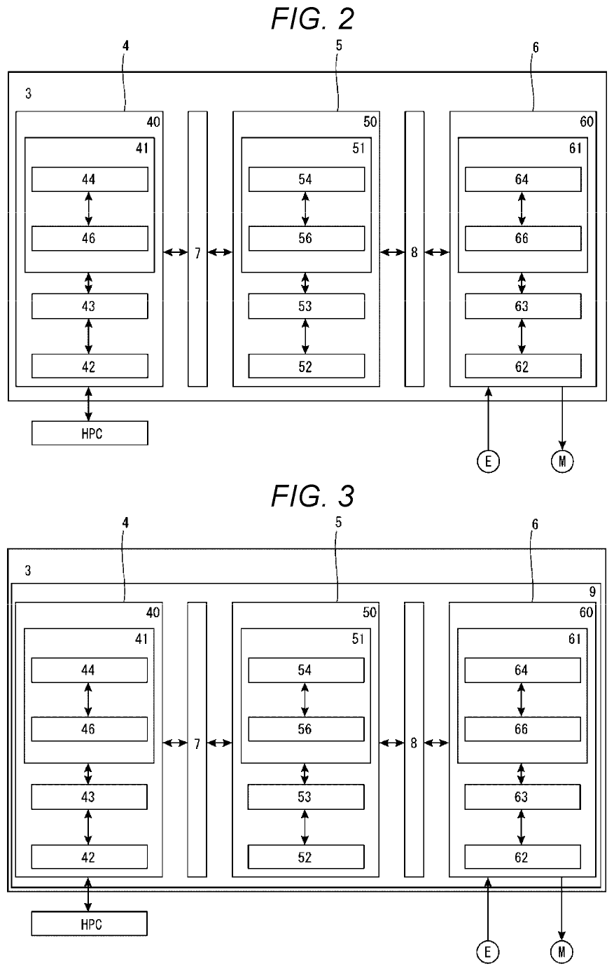

FIG. 1 shows an overall configuration of a robot system according to the preferred embodiment. FIG. 2 is a block diagram of the robot controller. FIG. 3 is a modification example of the block diagram of the robot controller shown in FIG. 2.

A robot system 1 shown in FIG. 1 has a robot 2 and a robot controller 3 controlling the driving of the robot 2.

### Robot 2

The robot 2 is, for example, a robot that performs work such as supplying, removing, transporting or assembling a precision device or a component forming the precision device. However, the application of the robot 2 is not particularly limited. The robot 2 is a six-axis robot having six axes of rotational movement. The robot 2 has a base 21 and a robot arm 22 coupled to the base 21 in a rotationally movable manner. An end effector 23 is attached to a distal end part of the robot arm 22.

The robot arm 22 is a robotic arm formed of a plurality of arms 221, 222, 223, 224, 225, 226 coupled together in a rotationally movable manner and has six joints J1 to J6. Of these joints, the joints J2, J3, J5 are bending joints and the joints J1, J4, J6 are torsion joints. Each of the joints J1, J2, J3, J4, J5, J6 has a motor M as a drive source and an encoder E for detecting the amount of rotation of the motor M, that is, position information of the motor M. A control point indicating the position of the robot arm 22 and serving as a control target is provided at an end part of the arm 226 at the distal end of the robot arm 22. As the respective motors M of the joints J1, J2, J3, J4, J5, J6 are driven independently of each other, the control point on the robot arm 22 can be moved along a desired trajectory.

The end effector 23 is coupled to the arm 226. As the end effector 23, an end effector that is attachable to and removable from the arm 226 and suitable for the work to be executed by the robot 2 can be selected and attached.

The robot 2 has been described above. However, the configuration of the robot 2 is not particularly limited. For example, the robot 2 may be a SCARA robot (horizontal articulated robot), a dual-arm robot or the like. The robot 2 may be fixed to a floor or the like and thus immovable, or may be fixed to a moving device such as an automated guided vehicle (AGV) and thus movable.

### Robot Controller 3

The robot controller 3 is accommodated, for example, in the base 21. However, the arrangement of the robot controller 3 is not particularly limited. For example, the robot controller 3 may be not accommodated in the robot 2. As shown in FIG. 2, the robot controller 3 has a first processing unit 4, a second processing unit 5, a third processing unit 6, a first external bus 7 coupling the first processing unit 4 and the second processing unit 5, and a second external bus 8 coupling the second processing unit 5 and the third processing unit 6.

The first processing unit 4 is coupled to a host computer HPC and accepts a program of the robot 2 from the host computer HPC. The first processing unit 4 has a function of executing a program causing the robot arm 22 to operate. The first processing unit 4 analyzes the accepted program and acquires target position information of the robot arm 22 designated in the program. The target position information is information about a target position P1, which is a target point to which the control point on the robot arm 22 is moved, for example, data representing the coordinates of the target position Pl. The target position information may also be information such as a distance moved by the control point on the robot arm 22 from the current position to the target position P1, or the like.

The first processing unit 4 transmits the acquired target position information to the second processing unit 5 via the first external bus 7. The second processing unit 5 has a function of generating a trajectory of the robot arm 22, based on the target position information accepted from the first processing unit 4. The second processing unit 5 transmits the generated trajectory to the third processing unit 6 via the second external bus 8. The third processing unit 6 is coupled to each motor M and has a function of sending a signal requesting position information to each encoder E, acquiring the position information detected by each encoder E, and performing servo control of the driving of each motor M, based on the trajectory accepted from the second processing unit 5. At this point, each of the processing units 4, 5, 6 needs to execute the function at a predetermined time interval. Particularly the third processing unit 6 sends the signal requesting the position information to each encoder E at a predetermined time interval. On the assumption that the detection of the position information is executed at a predetermined time interval in this way, the third processing unit 6 calculates the speed from the position of each motor M. The predetermined time interval is referred to as a control period. The control period is not particularly limited but may be, for example, approximately several tens of microseconds to several milliseconds.

In such a configuration, the program execution function, the trajectory generation function, and the motor control function can be allocated to the separate processing units 4, 5, 6 having main memories 42, 52, 62 and system buses 43, 53, 63, respectively. Therefore, these functions can be smoothly executed and the performance of the robot controller 3, particularly real-time performance, can be enhanced. Particularly in a robot controller where a plurality of functions share a main memory and a bus, if another function occupies the main memory and the bus, the trajectory generation function and the motor control function cannot access the main memory and this causes a delay in the generation of the trajectory and the control of the motor and also a delay in the timing of sending the signal requesting the position information to the encoder E. Consequently, the control period is shifted, causing a drop in the accuracy of the calculated speed and an increase in the discrepancy between the actual position and the detected position from the encoder E.

However, in such a configuration, the trajectory generation function and the motor control function can occupy the main memory and the system bus. Therefore, no delay is generated in the generation of the trajectory and the control of the motor, thus reducing the variation in the control period and making it easier to maintain a constant control period. Therefore, the discrepancy between the actual position and the detected position from the encoder E is reduced. The robot arm 22 is less likely to vibrate and the vibration can be swiftly converged. Thus, the next movement of the robot arm 22 can be quickly started. Consequently, the cycle time of the work is reduced and the productivity of the robot 2 is improved.

However, the function allocated to the first processing unit 4 is not particularly limited. For example, when the host computer HPC performs operations up to the analysis of the program and transmits the analyzed data, that is, the target position information, to the first processing unit 4, the first processing unit 4 may have a function of communicating with the host computer HPC.

The first processing unit 4 includes necessary functions integrated on one substrate. The first processing unit 4 has a first control unit 41, the first main memory 42 as a first storage unit, and the first system bus 43 coupling the first control unit 41 and the first main memory 42.

A printed wiring board 40 has an insulating substrate and a wiring and electrically couples the first control unit 41, the first main memory 42, and the first system bus 43 installed thereon. The first control unit 41 has a processor 44 and a cache memory 46. The first control unit 41 executes a program loaded in the first main memory 42 and thus implements the function of the first processing unit 4. The hardware configuration of the first control unit 41 is a system on a chip (SoC). Thus, the miniaturization, power saving, and cost reduction of the first control unit 41 can be achieved. Also, the first processing unit 4 can be manufactured easily. However, the hardware configuration of the first control unit 41 is not particularly limited and may be formed of, for example, the processor 44 and the cache memory 46 integrated on one substrate. The first control unit 41 may be configured without having the cache memory 46. The first main memory 42 stores a program and data. The first system bus 43 is a system bus coupling the processor 44 and the first main memory 42. In this specification, a transmission path coupled to the processor and transmitting data is a system bus regardless of whether the hardware configuration of the first control unit 41 is a system on a chip or not.

The processor 44 can read and execute the program stored in the first main memory 42. As the OS (operating system) of the processor 44, Linux (trademark registered), which is a general-purpose OS, is used. This makes it easier to execute the program and perform external communication. The cache memory 46 temporarily stores the program and the data read from the first main memory 42. The cache memory 46 has a smaller memory capacity than the first main memory 42 but can operate at a higher speed. The cache memory 46 is a multilevel cache memory and includes at least a primary cache memory and a secondary cache memory operating at a lower speed than the primary cache memory but having a larger memory capacity. The cache memory 46 may also include a tertiary and higher cache memories. The cache memory 46 may also be a single cache memory instead of a multilevel cache memory.

The processor 44 can be a multicore processor having a plurality of cores. In this case, the execution of different application programs can be allocated to the different cores. Therefore, each application program can be executed smoothly and the performance of the robot controller 3, particularly real-time performance, can be enhanced. Also, each core can be provided with a dedicated primary cache memory. In this case, a secondary cache memory may be provided in such a way as to be able to be shared by the plurality of cores. As the secondary cache memory is shared, the secondary cache memory can be effectively used. Also, each core may be provided with a dedicated secondary cache memory, as with the primary cache memory. As the dedicated secondary cache memory is provided for each core, a delay in the processing is restrained.

In the first processing unit 4 of the configuration as described above, the first control unit 41 can occupy the first main memory 42 and the first system bus 43. Therefore, a delay in the processing is restrained and the performance of the robot controller 3, particularly real-time performance, can be enhanced.

The second processing unit 5 is configured similarly to the first processing unit 4. Therefore, the second processing unit 5 will be briefly described below. The second processing unit 5 includes necessary functions integrated on one substrate. The second processing unit 5 has a printed wiring board 50, a second control unit 51, the second main memory 52 as a second storage unit, and the second system bus 53 coupling the second control unit 51 and the second main memory 52.

The second control unit 51 is a system on a chip (SoC) and has a processor 54 and a cache memory 56. The processor 54 can read and execute the program stored in the second main memory 52. In the second processing unit 5 of such a configuration, the second control unit 51 can occupy the second main memory 52 and the second system bus 53. Therefore, a delay in the processing is restrained and the performance of the robot controller 3, particularly real-time performance, can be enhanced.

The third processing unit 6 is configured similarly to the first processing unit 4. Therefore, the third processing unit 6 will be briefly described below. The third processing unit 6 includes necessary functions integrated on one substrate. The third processing unit 6 has a printed wiring board 60, a third control unit 61, the third main memory 62 as a third storage unit, and the third system bus 63 coupling the third control unit 61 and the third main memory 62.

The third control unit 61 is a system on a chip (SoC) and has a processor 64 and a cache memory 66. The processor 64 can read and execute the program stored in the third main memory 62. In the third processing unit 6 of such a configuration, the third control unit 61 can occupy the third main memory 62 and the third system bus 63. Therefore, a delay in the processing is restrained and the performance of the robot controller 3, particularly real-time performance, can be enhanced. Since the control units 41, 51, 61 are provided with the dedicated cache memories 46, 56, 66, respectively, as described above, the control units 41, 51, 61 can occupy the cache memories 46, 56, 66, respectively, thus restraining a delay in the processing.

The first external bus 7 is a transmission path for transmitting data and couples the first processing unit 4 and the second processing unit 5 together. Thus, information can be communicated between the first processing unit 4 and the second processing unit 5. The first processing unit 4 writes information shared with the second processing unit 5 into the second main memory 52 via the first external bus 7. The second processing unit 5 writes information shared with the first processing unit 4 into the first main memory 42 via the first external bus 7. Thus, the first processing unit 4 can acquire necessary information without accessing the second main memory 52 and therefore the processing speed is improved. The same applies to the second processing unit 5.

The second external bus 8 is a transmission path for transmitting data and couples the second processing unit 5 and the third processing unit 6 together. Thus, information can be communicated between the second processing unit 5 and the third processing unit 6. The second processing unit 5 writes information shared with the third processing unit 6 into the third main memory 62 via the second external bus 8. The third processing unit 6 writes information shared with the second processing unit 5 into the second main memory 52 via the second external bus 8. Thus, the second processing unit 5 can acquire necessary information without accessing the third main memory 62 and therefore the processing speed is improved. The same applies to the third processing unit 6.

The standard of the first and second external buses 7, 8 is not particularly limited. For example, ISA, PCI, PCI Express (PCIe), AGP or the like can be used. In the above description, each of the first processing unit 4, the second processing unit 5, and the third processing unit 6 has one substrate. However, the processing units 4, 5, 6 may be provided on a printed wiring board 9 as a single substrate, as shown in FIG. 3.

The robot system 1 has been described above. The robot controller 3 provided in such a robot system 1 is a robot controller controlling the robot arm 22 driven by the motor M. The robot controller 3 includes: the first processing unit 4 having the first control unit 41, the first main memory 42 as the first storage unit, and the first system bus 43 that couples the first control unit 41 and the first main memory 42 together, the first processing unit 4 executing the program causing the robot arm 22 to operate or communicating with outside (host computer HPC) and thus acquiring the target position information designated in the program causing the robot arm 22 to operate; and the second processing unit 5 having the second control unit 51, the second main memory 52 as the second storage unit, and the second system bus 53 that couples the second control unit 51 and the second main memory 52 together, the second processing unit 5 receiving the target position information from the first processing unit 4 and generating the trajectory of the robot arm 22, based on the target position information. In such a configuration, the program execution function or the communication function, and the trajectory generation function, can be allocated separately to the first processing unit 4 and the second processing unit 5. Therefore, these functions can be smoothly executed and the performance of the robot controller 3, particularly real-time performance, can be enhanced. Thus, the productivity of the robot 2 is improved.

As described above, the robot controller 3 has the first external bus 7 coupling the first processing unit 4 and the second processing unit 5 together. Thus, information can be communicated between the first processing unit 4 and the second processing unit 5.

As described above, the first processing unit 4 writes information shared with the second processing unit 5 into the second main memory 52. The second processing unit 5 writes information shared with the first processing unit 4 into the first main memory 42. Thus, the first processing unit 4 can acquire necessary information without accessing the second main memory 52 and therefore the processing speed is improved. The same applies to the second processing unit 5. That is, the second processing unit 5 can acquire necessary information without accessing the first main memory 42 and therefore the processing speed is improved.

As described above, each of the first control unit 41 and the second control unit 51 is a system on a chip. Thus, the miniaturization, power saving, and cost reduction of the first and second processing units 4, 5 can be achieved. Also, the first and second processing units 4, 5 can be manufactured easily.

As described above, the robot controller 3 also has the third processing unit 6 having the third control unit 61, the third main memory 62 as the third storage unit, and the third system bus 63 coupling the third control unit 61 and the third main memory 62 together, the third processing unit 6 controlling the driving of the motor M. As the motor control function is thus allocated to the third processing unit 6, which is different from the first and second processing units 4, 5, the motor control function can be executed smoothly. Therefore, the performance of the robot controller 3, particularly real-time performance, can be enhanced. Thus, the productivity of the robot 2 is improved.

As described above, the robot controller 3 also has the second external bus 8 coupling the second processing unit 5 and the third processing unit 6 together. Thus, information can be communicated between the second processing unit 5 and the third processing unit 6.

As described above, the operating system of the first processing unit 4 is Linux (trademark registered). This makes it easier to execute the program and perform external communication.

As described above, the robot system 1 includes: the robot 2 having the robot arm 22; and the robot controller 3 controlling the driving of the robot arm 22. The robot controller 3 includes: the first processing unit 4 having the first control unit 41, the first main memory 42 as the first storage unit, and the first system bus 43 that couples the first control unit 41 and the first main memory 42 together, the first processing unit 4 executing the program causing the robot arm 22 to operate or communicating with outside (host computer HPC) and thus acquiring the target position information designated in the program causing the robot arm 22 to operate; and the second processing unit 5 having the second control unit 51, the second main memory 52 as the second storage unit, and the second system bus 53 that couples the second control unit 51 and the second main memory 52 together, the second processing unit 5 receiving the target position information from the first processing unit 4 and generating the trajectory of the robot arm 22, based on the target position information. In such a configuration, the program execution function or the communication function, and the trajectory generation function, can be allocated separately to the first processing unit 4 and the second processing unit 5. Therefore, these functions can be smoothly executed and the performance of the robot controller 3, particularly real-time performance, can be enhanced. Thus, the productivity of the robot 2 is improved.

The robot controller and the robot system according to the present disclosure have been described above, based on the illustrated embodiment. However, the present disclosure is not limited to this embodiment. The configuration of each unit can be replaced with any configuration having a similar function. Also, any other configuration may be added to the present disclosure.

What is claimed is:

1. A robot controller controlling a robot arm driven by a motor, the robot controller comprising:
a first processing unit having a first control unit, a first storage unit, and a first system bus that couples the first control unit and the first storage unit together, the first processing unit acquiring target position information designated in a program causing the robot arm to operate; and
a second processing unit having a second control unit, a second storage unit, and a second system bus that couples the second control unit and the second storage unit together, the second processing unit receiving the target position information from the first processing unit and generating a trajectory of the robot arm, based on the target position information.

2. The robot controller according to claim 1, further comprising:
a first external bus coupling the first processing unit and the second processing unit together.

3. The robot controller according to claim 1, wherein
the first processing unit writes information shared with the second processing unit into the second storage unit, and
the second processing unit writes information shared with the first processing unit into the first storage unit.

4. The robot controller according to claim 1, wherein
each of the first control unit and the second control unit is a system on a chip.

5. The robot controller according to claim 1, further comprising:
a third processing unit having a third control unit, a third storage unit, and a third system bus coupling the third control unit and the third storage unit together, the third processing unit controlling driving of the motor.

6. The robot controller according to claim 5, further comprising:
a second external bus coupling the second processing unit and the third processing unit together.

7. The robot controller according to claim 1, wherein
an operating system of the first processing unit is Linux (trademark registered).

8. A robot system comprising:
a robot having a robot arm; and
a robot controller controlling driving of the robot arm,
the robot controller comprising:
a first processing unit having a first control unit, a first storage unit, and a first system bus that couples the first control unit and the first storage unit together, the first processing unit acquiring target position information designated in a program causing the robot arm to operate; and
a second processing unit having a second control unit, a second storage unit, and a second system bus that couples the second control unit and the second storage unit together, the second processing unit receiving the target position information from the first processing unit and generating a trajectory of the robot arm, based on the target position information.
